(19) United States
(12) Patent Application Publication
(10) Pub. No.: US 2018/0054961 A1
(43) Pub. Date: Mar. 1, 2018

(54) Shield for a Weed Trimmer

(71) Applicant: Keith Labare, New Castle, CO (US)

(72) Inventor: Keith Labare, New Castle, CO (US)

(21) Appl. No.: 15/251,603

(22) Filed: Aug. 30, 2016

(51) Int. Cl. A01D 34/416

(52) U.S. Cl. CPC A01D 34/4167

(57) ABSTRACT

The invention is directed to a transparent shield for use with a line fed weed trimmer wherein the trimmer includes a rotating head mounted on a shaft that feeds cutting line around a central axis in a plane of rotation. The transparent shield is mounted directly above the rotating head and extends partway around the axis to partially cover the path of the cutting line within the plane. The transparent shield further includes a non-stick coating, such as Teflon®. The transparent shield mounted directly above the rotating head and the non-stick coating provide an operator of the weed trimmer with a clear view of the trimmer's cutting path. In addition, the transparent shield may be equipped with a cutting instrument along the periphery of the shield so as to better manage flailing line fed from the rotating head.

### TECHNICAL FIELD

The present invention relates to the field of weed trimmers. More specifically, the invention relates to a shield for a gas or electric engine powered weed trimmer that is transparent, made of a durable polycarbonate plastic, and coated with a non-stick substance.

### BACKGROUND

Weed trimmers of the line cutting type are traditionally used to edge and trim vegetation growth. The weed trimmers are designed to include a shaft that includes mounted on one end a line spooled rotating head driven by an electric or gas powered motor mounted on another end wherein the rotating head feeds cutting line along a plane of rotation. The weed trimmers further include a shield or shield that encompasses only a section of the rotating head positioned along the drive shaft so as to allow an operator to see what they are trimming upstream and trim in hard to reach areas as well as shield the operator from debris that may be deflected in the downstream. It is the operational deficiencies of the traditional shields or shields used with traditional weed trimmers that is a concern.

An example of a popular weed trimmer often used in commercial settings would be the Husqvarna® brand. A problem with this type of weed trimmer is that the partial shield used may allow the operator to see what is upstream while operating, it does not, however, allow the operator to see what is directly underneath the shield while operating. For example, the operator may be using the weed trimmer to trim tall and thick vegetation. In typical use, the operator may cut a section of tall and thick vegetation at a height from the ground and then lower the trimmer head to get a better cut. However, if the operator can not see what is underneath, the operator or others could get injured or the equipment or surrounding property could get damaged by what is underneath. In addition, these shields are typically made from cheap plastics that lack durability. As such, the these shields often break when operating or transporting, leaving the operator or business owner with added costs. Another problem with these types of weed trimmers is that when in use the line can be fed out to extend beyond the length of the shield. The problem with this is that the user does not get a proper cut. Also, a problem with this that the user can trim that which was not intended to be cut. Additionally, the user then has to stop his work to cut the line to an acceptable length.

As such, an object of the invention is to provide a weed trimmer shield that is safer, more durable, and more cost efficient to operate.

### SUMMARY

The objectives of the invention are achieved by providing a shield assembly for use with the line fed weed trimmer wherein the shield assembly includes a transparent shield, e.g. made from Lexan®, mounted directly above the trimmer's rotating head and is coated with a non-stick coating, such as Teflon®. The objectives are further achieved by including a cutting instrument along a periphery of the shield to maintain the length of the cutting line.

### BRIEF DESCRIPTION OF THE DRAWINGS

FIG. 1 is a perspective view of part of a weed trimmer that illustrates the transparent shield according to an embodiment of the invention.

### DETAILED DESCRIPTION OF THE INVENTION

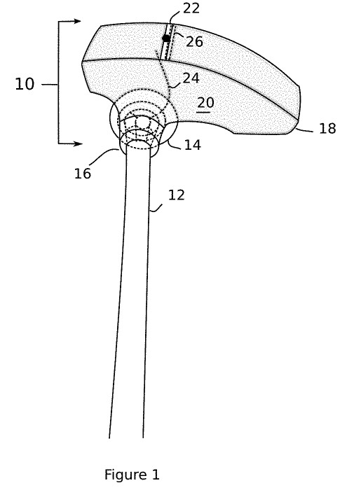

Referring to FIG. 1, illustrated is a weed shield assembly for use with a weed trimmer according to an embodiment of the invention wherein the shield assembly is denoted generally as 10. For the purpose of brevity and clarity, the gas or electric engine of the weed trimmer is not illustrated, as these features are commonly understood in the current state of the art. However, the focal point of the invention is the shield assembly 10 and its attachment and use with the gas or electric powered engine through a shaft 12 and trimmer cutting head 14. The shield assembly 10, as illustrated, couples with the shaft 12 using a collar 16, either physically attached to the shield 10 or formed therewith, and partially surrounds the trimmer cutting head 14. The trimmer cutting head 14 rotates about a center axis and can feed cutting line along a plane of the axis that is at least partially covered by the shield 10.

The shield assembly 10 includes a clear shield 18 coupled with the collar 16, a non-stick coating 20, and a cutting assembly 22. The clear shield 18 may be made of a polycarbonate, such as Lexan®. The non-stick coating 20 may be made of a polytetrafluorethylene, such as Teflon®, and may cover the entire shield 18 including the cutting assembly 22 or only a portion of the shield 18, e.g. the underside of the shield 18. The combination of the polycarbonate and polytetrafluorethylene provide the operator of the weed trimmer with an unobstructed view of the cutting path directly beneath the shield.

The clear shield 18 is coupled directly above the trimmer cutting head 14 and partially surrounds the cutting head 14 so as to allow an operator to see trimming line 24 fed from the trimmer cutting head 14. Traditionally, a shield used in this capacity partially surrounds the cutting head in a way that protects the operator from debris deflected in the downstream while allowing the operator to see what is being cut in the upstream. In this manner, transparent shield 18 covers the trimmer cutting head 14 in a way that protects the operator from deflected debris but also allows the operator to see what is in the path of flailing trimming line 24. In so doing, the operator can better manage the weed trimmer so as not to strike non vegetation debris that could cause harm or damage. The non-stick coating 20 also helps prevent cut vegetation from sticking to the undercarriage of the shield 18 and obstructing the operator's view.

The cutting assembly 22 may be placed along a periphery of the shield 12, e.g. along the lip of the shield as illustrated in FIG. 1. The cutting assembly 22 includes a blade 26 wherein the length the blade 26 extends from the periphery can be adjusted according to the operator's needs. As such, the length of the flailing line 24 can be managed by the blade so as to provide the operator with a more accurate and efficient cutting instrument.

Thus, While there have been shown and described and pointed out fundamental novel features of the invention as applied to a preferred embodiment thereof, it will be under stood that various omissions and substitutions and changes in the form and details of the devices illustrated, and in their operation, may be made by those skilled in the art without departing from the spirit of the invention. For example, it is expressly intended that all combinations of those elements and/or method steps Which perform substantially the same function in substantially the same Way to achieve the same results are Within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A shield assembly for use with a line fed weed trimmer wherein the trimmer includes a rotating head mounted on a shaft that feeds cutting line around an axis of rotation in a plane, the shield assembly comprising:
a transparent shield mounted directly above the rotating head and extending partway around the axis;
a cutting instrument attached to the transparent shield in the path of the plane in which the line is fed at a predetermined distance from the axis so as to trim segments of the line that extend in access of the distance from the axis; and
a non-stick coating on at least a portion of the transparent shield assembly.

2. The shield assembly of claim 1 wherein the transparent shield is made of a polycarbonate.

3. The shield assembly of claim 1 wherein the non-stick coating is made of polytetrafluorethylene.

4. The shield assembly of claim 1 wherein the non-stick coating is on at least a portion of the transparent body.

5. The shield assembly of claim 1 wherein the non-stick coating is on the cutting instrument.
